(19) United States
(12) Patent Application Publication
(10) Pub. No.: US 2011/0050554 A1
(43) Pub. Date: Mar. 3, 2011

(54) DISPLAY DEVICE AND BACKLIGHT CONTROL METHOD THEREOF

(76) Inventors: Chun-Chieh Yu, Taipei City (TW); Yi-Chiang Lai, Taoyuan County (TW)

(21) Appl. No.: 12/577,218

(22) Filed: Oct. 12, 2009

(30) Foreign Application Priority Data
Sep. 3, 2009 (TW) 098129673

(51) Int. Cl. G09G 3/36

(52) U.S. Cl. 345/102

(57) ABSTRACT

A display device includes a panel, a receiving interface, a timing control module, a backlight module and a backlight driving unit. The receiving interface receives a first data signal and a first backlight control signal with a first timing. The timing control module converts the first data signal into a second data signal and then outputs the second data signal to the panel. Furthermore, based on the second data signal, the timing control module converts the first backlight control signal into a second backlight control signal with a second timing different from the first timing and then outputs the second backlight control signal. After receiving the second backlight control signal from the timing control module, the backlight driving unit is controlled by the second backlight control signal to output an output voltage signal to the backlight module.

### BACKGROUND OF THE INVENTION

1. Field of the Invention

The invention relates to a display device and, more particularly, to a device and method thereof for controlling backlight timing of a display device.

2. Description of the Prior Art

A liquid crystal display (LCD) using light emitting diodes as a backlight module is usually applied to a notebook. Referring to FIG. 1, FIG. 1 is a functional block diagram illustrating a conventional LCD 1. As shown in FIG. 1, a panel power 20 and a data signal 22 are transmitted from external devices to a timing control module 12 via a receiving interface 10. After process and transformation, the timing control module 12 outputs a data/control signal 24 to a source/gate driver 140 of a panel 14. Furthermore, an LED backlight power 26 and an LED backlight control signal 28 are also transmitted from external devices to an LED backlight driving unit 16 via the receiving interface 10, so as to control a voltage 30 and a feedback current 32 for an LED backlight module 18. In general, the LED backlight control signal 28 comprises a pulse width modulation (PWM) signal 280 and an enable signal 282. The PWM signal 280 is used for controlling brightness of the LED backlight module 18 and the enable signal 282 is used for controlling on/off of the LED backlight module 18. In the past, the LED backlight driving unit 16 is controlled by the LED backlight control signal 28 directly. If the LED backlight control signal 28 has noise or does not be outputted based on correct timing when power is on, some undesired images, such as white image or power-on noise, will be displayed on the panel 14.

Referring to FIG. 2, FIG. 2 is a timing diagram illustrating the backlight powered on under normal and abnormal conditions. As shown in FIG. 2, the normal condition shows a desired on/off timing for common panels. After supplying the panel power 20 to the panel 14, the timing control module 12 will reach steady state after time t0-t2 and the data signal 22 is then inputted. After time t2-t3, the data signal 22 will reach steady state and the voltage 30 is then inputted, so as to prevent the panel 14 from displaying undesired images while the LED backlight module 18 is powered on. On the other hand, the LED backlight module 18 should be powered off before time t4, so as to avoid generating power-off noise.

However, if the LED backlight control signal 28 from external devices is abnormal, the panel will display images with noise while power is on or off. As shown in FIG. 2, the enable signal 282 is used for controlling on/off of the LED backlight driving unit 16. For example, the LED backlight driving unit 16 is on while the enable signal 282 is high and the LED backlight driving unit 16 is off while the enable signal 282 is low. The PWM signal 280 is used for controlling output current of the LED backlight driving unit 16, so as to adjust brightness of the LED backlight module 18. As shown in FIG. 2, the sum of time t_on and time t_off is constant, and there is positive correlation between the time t_on and the output current of the LED backlight driving unit 16 (i.e. the brightness of the backlight module 18). Moreover, as shown in FIG. 2, the voltage 30′ will be transmitted from the LED backlight driving unit 16 to the LED backlight module 18 while the abnormal condition occurs. For example, the LED is on while the voltage 30′ is high and the LED is off while the voltage 30′ is low.

When power is on and provided that the power of the LED backlight driving unit 16 has reached steady state, a transient voltage occurs in the enable signal 282 during time t0-t1 and the PWM signal 280 is high. At this time, the LED backlight driving unit 16 will output voltage to power on the LED backlight module 18 at time interval a. After the time interval a, the enable signal 282 is pulled low and then the LED backlight driving unit 16 stops to output voltage, such that the LED backlight module 18 is powered off. At time t1-t2 within time interval b, the enable signal 282 is pulled high again, so that the LED backlight module 18 is powered on again. It should be noted that, at time t2-t3 within the time interval b, the data signal 22 may not reach steady state yet, such that the panel 14 may display an image with noise. At this time, since the LED backlight module 18 has been powered on, the panel 14 will display the image with noise clearly. After time t3, the enable signal 282 is pulled low again, so that the LED backlight module 18 is powered off again.

When power is off (i.e. after time t4), the LED backlight module 18 should be powered off at the same time under normal condition. However, since the enable signal 282 and the PWM signal 280 are still pulled high, the LED backlight driving unit 16 will be on. Accordingly, the panel may display images with noise due to unstable data signal 22 during time t4-t5 and display white image during time t5-t6 (provided that the panel 14 will display white image while there is no data signal).

### SUMMARY OF THE INVENTION

Therefore, one objective of the invention is to provide a display device and backlight control method thereof for controlling timing of the backlight control signal, such as enable signal and/or PWM signal, so as to solve the aforesaid problems.

According to one embodiment, a display device of the invention comprises a panel, a receiving interface, a timing control module, a backlight module and a backlight driving unit. The timing control module is electrically connected to the receiving interface and the panel. The backlight driving unit is electrically connected to the receiving interface, the timing control module and the backlight module. The receiving interface receives a first data signal and a first backlight control signal with a first timing. The timing control module converts the first data signal into a second data signal and then outputs the second data signal to the panel. Furthermore, based on the second data signal, the timing control module converts the first backlight control signal into a second backlight control signal with a second timing different from the first timing and then outputs the second backlight control signal. After receiving the second backlight control signal from the timing control module, the backlight driving unit is controlled by the second backlight control signal to output an output voltage signal to the backlight module.

According to another embodiment, a backlight control method of the invention comprises steps of: receiving a first data signal and a first backlight control signal with a first timing; converting the first data signal into a second data signal and then outputting the second data signal to a panel; based on the second data signal, converting the first backlight control signal into a second backlight control signal with a second timing different from the first timing and then outputting the second backlight control signal; and based on the second backlight control signal, outputting an output voltage signal to a backlight module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a conventional LCD.

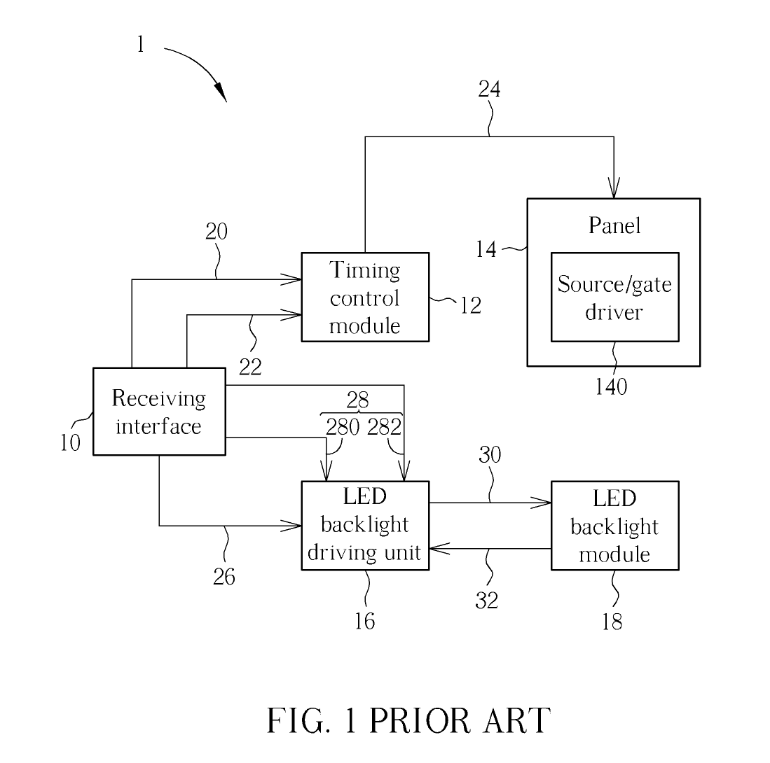

FIG. 2 is a timing diagram illustrating the backlight powered on under normal and abnormal conditions.

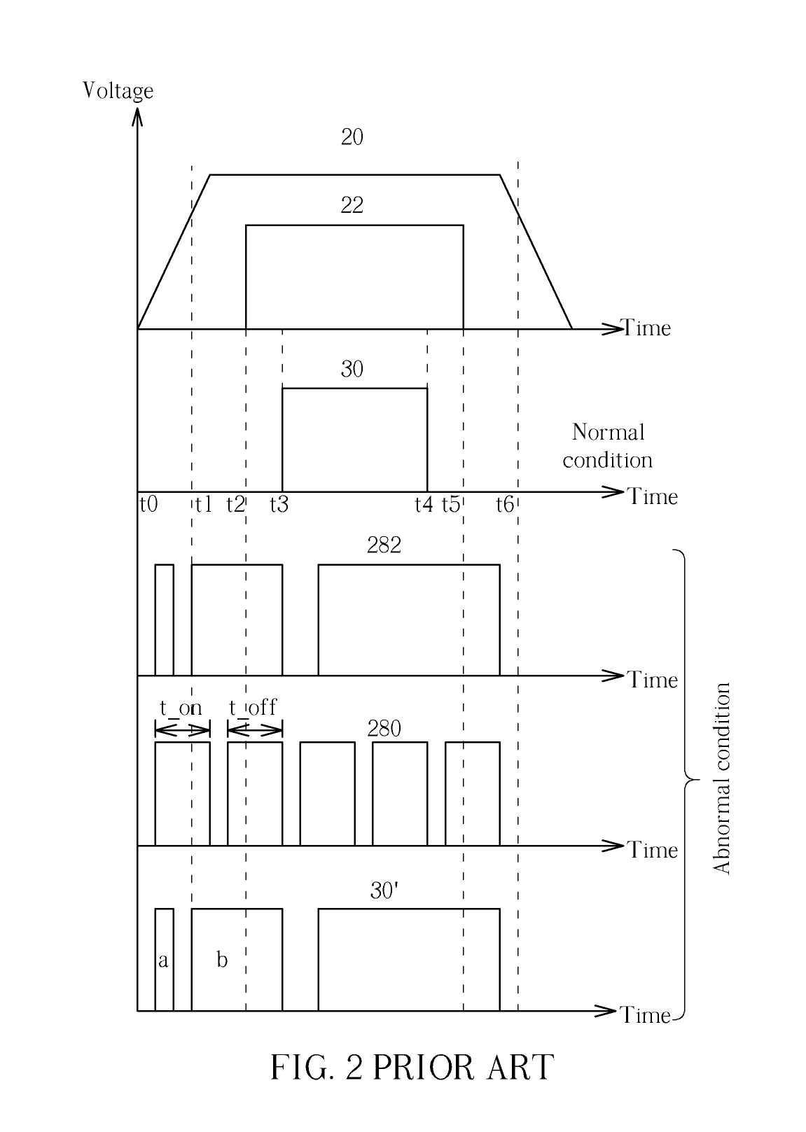

FIG. 3 is a functional block diagram illustrating a display device according to one embodiment of the invention.

FIG. 4 is a functional block diagram illustrating the timing control module shown in FIG. 3.

FIG. 5 is a timing diagram illustrating backlight control of the invention.

FIG. 6 is a flowchart showing a backlight control method according to one embodiment of the invention.

FIG. 7 is a flowchart showing a backlight control method according to another embodiment of the invention.

### DETAILED DESCRIPTION

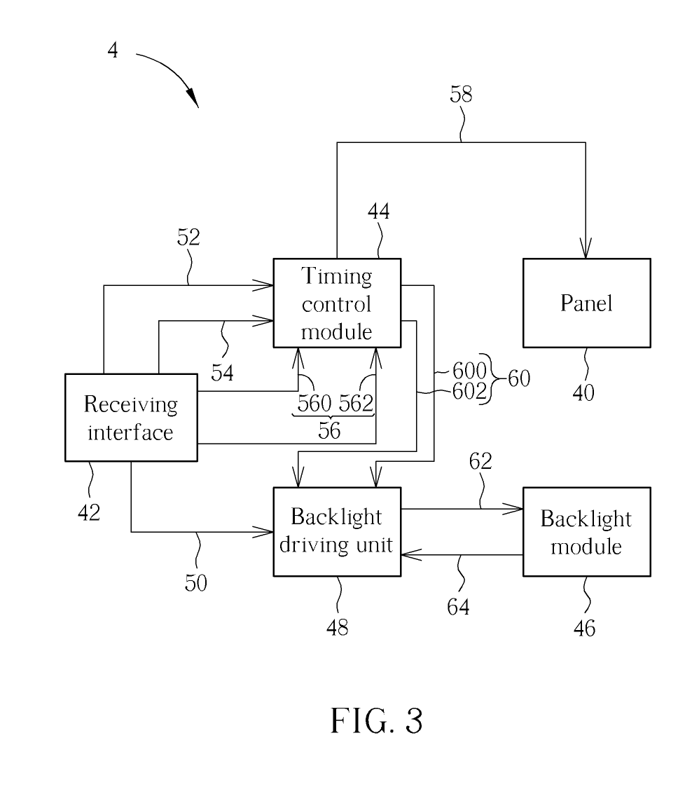

Referring to FIG. 3, FIG. 3 is a functional block diagram illustrating a display device 4 according to one embodiment of the invention. As shown in FIG. 3, the display device 4 comprises a panel 40, a receiving interface 42, a timing control module 44, a backlight module 46 and a backlight driving unit 48. The timing control module 44 is electrically connected to the receiving interface 42 and the panel 40. The backlight driving unit 48 is electrically connected to the receiving interface 42, the timing control module 44 and the backlight module 46. In practical applications, the display device 4 can be, but not limited to, a liquid crystal display, the panel 40 can be, but not limited to, a liquid crystal panel, and the backlight module 46 can be, but not limited to, an LED backlight module.

The receiving interface 42 receives a first input voltage signal 50 and a second input voltage signal 52 from external devices. Afterward, the receiving interface 42 supplies the first input voltage signal 50 to the backlight driving unit 48 and supplies the second input voltage signal 52 to the timing control module 44. Furthermore, the receiving interface 42 also receives a first data signal 54 and a first backlight control signal 56 with a first timing from external devices. In this embodiment, the first backlight control signal 56 comprises a PWM signal 560 and an enable signal 562. The PWM signal 560 is used for controlling brightness of the backlight module 46 and the enable signal 562 is used for controlling on/off of the backlight module 46. The PWM signal 560 and the enable signal 562 both have the first timing.

The timing control module 44 is driven by the second input voltage signal 52 to convert the first data signal 54 into a second data signal 58 and output the second data signal 58 to the panel 40. Furthermore, based on the second data signal 58, the timing control module 44 converts the first backlight signal 56 into a second backlight control signal 60 with a second timing different from the aforesaid first timing and then outputs the second backlight control signal 60 to the backlight driving unit 48. As mentioned in the above, since the first backlight control signal 56 comprises the PWM signal 560 and the enable signal 562, the second backlight control signal 60 also comprises a PWM signal 600 and an enable signal 602 and the PWM signal 600 and the enable signal 602 both have the second timing.

After receiving the second backlight control signal 60 from the timing control module 44, the backlight driving unit 48 is controlled by the second backlight control signal 60 to output an output voltage signal 62 to the backlight module 46, so as to power on the backlight module 46. Moreover, the backlight module 46 will output a feedback current 64 to the backlight driving unit 48. The backlight driving unit 48 can unify brightness of the backlight module 46 based on the feedback current 64.

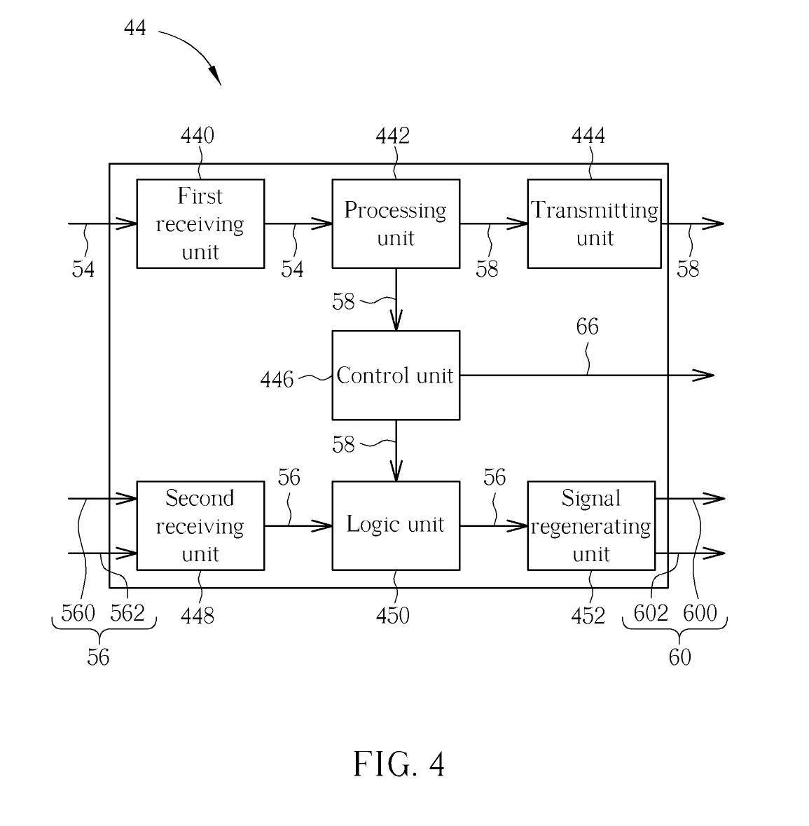

Referring to FIG. 4, FIG. 4 is a functional block diagram illustrating the timing control module 44 shown in FIG. 3. As shown in FIG. 4, the timing control module comprises a first receiving unit 440, a processing unit 442, a transmitting unit 444, a control unit 446, a second receiving unit 448, a logic unit 450 and a signal regenerating unit 452. The first receiving unit 440 is electrically connected to the receiving interface 42, the processing unit 442 is electrically connected to the first receiving unit 440, the transmitting unit 444 is electrically connected to the processing unit 442 and the panel 40, the control unit 446 is electrically connected to the processing unit 442 and the panel 40, the second receiving unit 448 is electrically connected to the receiving interface 42, the logic unit 450 is electrically connected to the control unit 446 and the second receiving unit 448, and the signal regenerating unit 452 is electrically connected to the logic unit 450 and the backlight driving unit 48.

The first receiving unit 440 receives the first data signal 54 from the receiving interface 42 and transmits the first data signal 54 to the processing unit 442. The processing unit 442 converts the first data signal 54 into the second data signal 58 in a specific format in compliance with the panel 40 and then transmits the second data signal 58 to the transmitting unit 444 and the control unit 446. The transmitting unit 444 outputs the second data signal 58 to the panel 40. Furthermore, based on the second data signal 58, the control unit 446 outputs control signals 66, such as start pulse (STH) signal, latch pulse (LP) signal, point of load (POL) signal, see through vision (STV) signal, output enable (OE) signal and so on, to the panel 40.

Moreover, after receiving the first backlight control signal 56 from the receiving interface 42, the second receiving unit 448 transmits the first backlight control signal 56 to the logic unit 450. At this time, the logic unit 450 determines whether the second data signal 58 has been transmitted to the panel 40 or terminated first. Once the second data signal 58 has been transmitted to the panel 40 or terminated, the signal regenerating unit 452 converts the first backlight control signal 56 into the second backlight control signal 60 and then outputs the second backlight control signal 60 to the backlight driving unit 48.

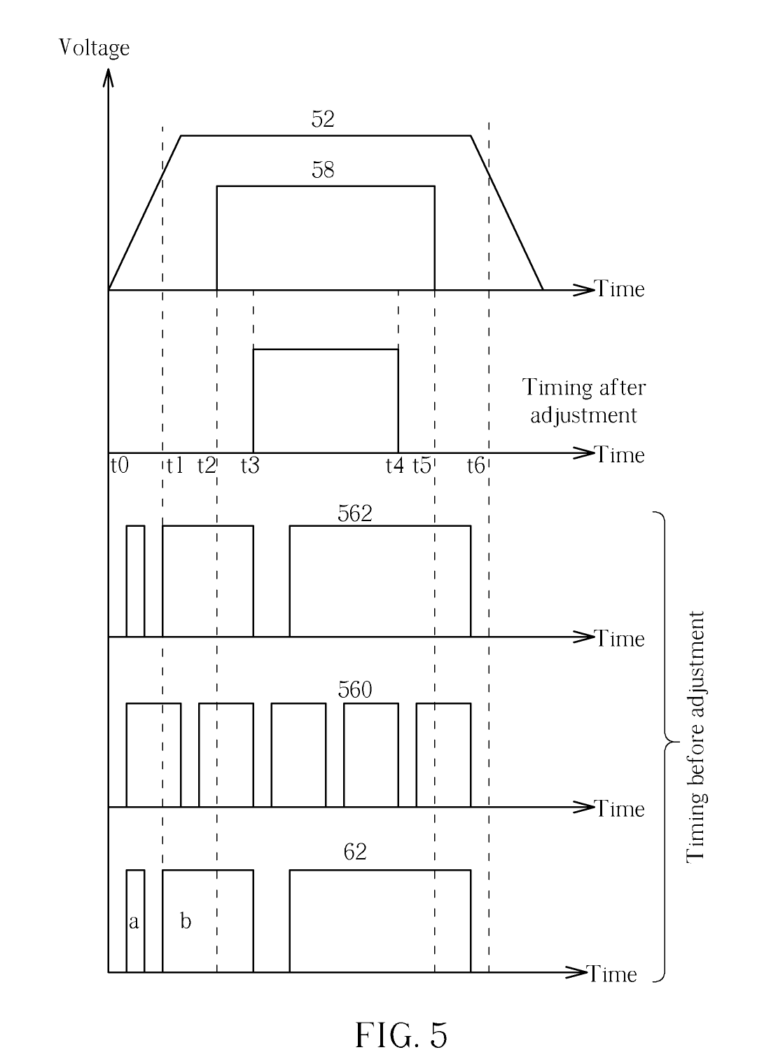

Referring to FIG. 5 along with FIGS. 3 and 4, FIG. 5 is a timing diagram illustrating backlight control of the invention. As shown in FIG. 5, the PWM signal 560 and the enable signal 562 both have an abnormal timing before adjustment. When power is on at time t0 and provided that the power of the backlight driving unit 48 has reached steady state, a transient voltage occurs in the enable signal 562 during time t0-t1 and the PWM signal 560 is high. At this time, the backlight driving unit 48 will output the output voltage signal 62 to power on the backlight module 46 at time interval a. After the time interval a, the enable signal 562 is pulled low and then the backlight driving unit 48 stops to output voltage, such that the backlight module 46 is powered off. At time t1-t2 within time interval b, the enable signal 562 is pulled high again, so that the backlight module 46 is powered on again. It should be noted that, at time t2-t3 within the time interval b, the data signal 58 may not reach steady state yet, such that the panel 40 may display an image with noise. At this time, since the backlight module 46 has been powered on, the panel 40 will display the image with noise clearly.

In general, after supplying the second input voltage signal 52 to the panel 40, the timing control module 44 will reach steady state after time t0-t2 and the data signal 58 is then inputted. To avoid the aforesaid situation, the backlight driving unit 48 should output voltage to the backlight module 46 after time t2-t3 when the data signal 58 has reached steady state, so as to prevent the panel 40 from displaying undesired images while the backlight module 46 is powered on.

In one embodiment, after the transmitting unit 444 transmits the second data signal 58 to the panel 40, the logic unit 450 of the invention may determine that the second data signal 58 has been transmitted to the panel 40 after a first predetermined time. Then, the logic unit 450 outputs a control signal to control the signal regenerating unit 452 to adjust the timing of the PWM signal 560 and the enable signal 562 to be the timing after adjustment shown in FIG. 5. In this embodiment, the aforesaid first predetermined time represents time t2-t3 shown in FIG. 5. Therefore, the backlight driving unit 48 will be controlled by the adjusted PWM signal 560 and enable signal 562 to output the output voltage signal 62 to the backlight module 46, so as to power on the backlight module 46 at time t3. Since the data signal 58 has reached steady state at time t3, the panel 40 will display images without noise.

In another embodiment, after the timing control module 44 receives the second input voltage signal 52, the logic unit 450 of the invention may determine that the second data signal 58 has been transmitted to the panel 40 after a second predetermined time. Then, the logic unit 450 outputs a control signal to control the signal regenerating unit 452 to adjust the timing of the PWM signal 560 and the enable signal 562 to be the timing after adjustment shown in FIG. 5. In this embodiment, the aforesaid second predetermined time represents time t0-t3 shown in FIG. 5.

In another embodiment, after the timing control module 44 receives the second input voltage signal 52 and reaches steady state, the logic unit 450 of the invention may determine that the second data signal 58 has been transmitted to the panel 40 after a third predetermined time. Then, the logic unit 450 outputs a control signal to control the signal regenerating unit 452 to adjust the timing of the PWM signal 560 and the enable signal 562 to be the timing after adjustment shown in FIG. 5. In this embodiment, the aforesaid third predetermined time represents time t1-t3 shown in FIG. 5.

On the other hand, the backlight module 46 should be powered off before time t4, so as to avoid generating power-off noise. Since time t4-t5 when the second data signal 58 will be terminated cannot be obtained, the timing control module 44 of the invention may pull low the PWM signal 560 and the enable signal 562 at time t5 when the second data signal is terminated, so as to power off the backlight module 46. Accordingly, the power-off noise can be avoided.

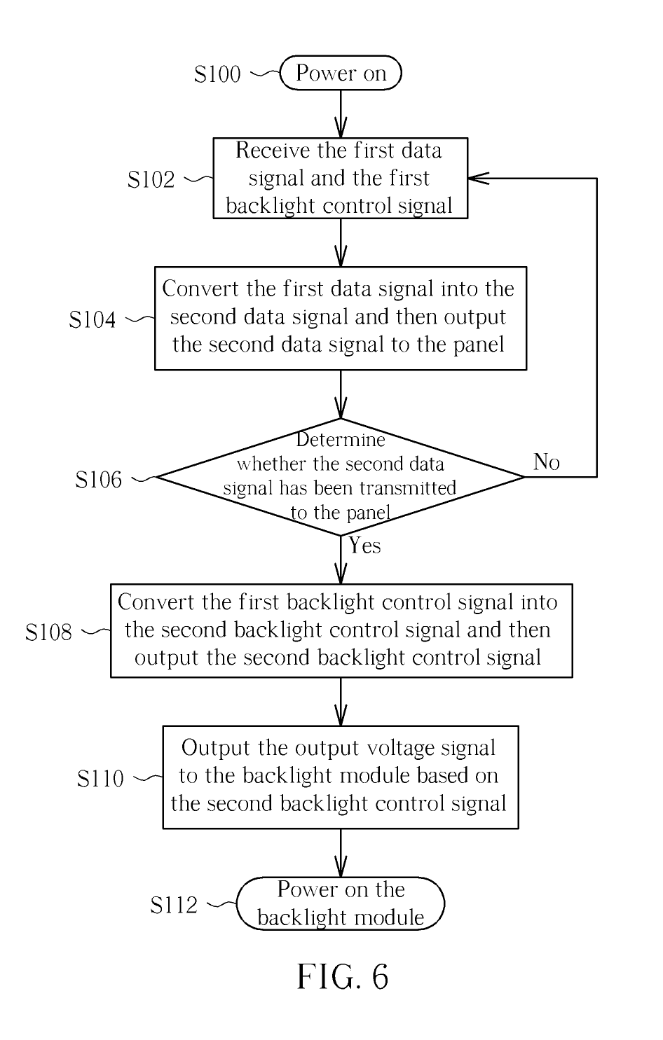

Referring to FIG. 6 along with FIGS. 3 and 4, FIG. 6 is a flowchart showing a backlight control method according to one embodiment of the invention. When the display device 4 is powered on, the backlight control method of the invention comprises the following steps. In the beginning, step S100 is performed to power on the display device 4. Afterward, step S102 is performed to receive the first data signal 54 and the first backlight control signal 56. Step S104 is then performed to convert the first data signal 54 into the second data signal 58 and then output the second data signal 58 to the panel 40. Step S106 is then performed to determine whether the second data signal 58 has been transmitted to the panel 40, wherein if it is YES, step S108 will be performed, otherwise step S102 is performed again to receive the first data signal 54 and the first backlight control signal 56 continuously. Step S108 is performed to convert the first backlight control signal 56 into the second backlight control signal 60 and then output the second backlight control signal 60. Step S110 is then performed to output the output voltage signal 62 to the backlight module 46 based on the second backlight control signal 60. Finally, step S112 is performed to power on the backlight module 46.

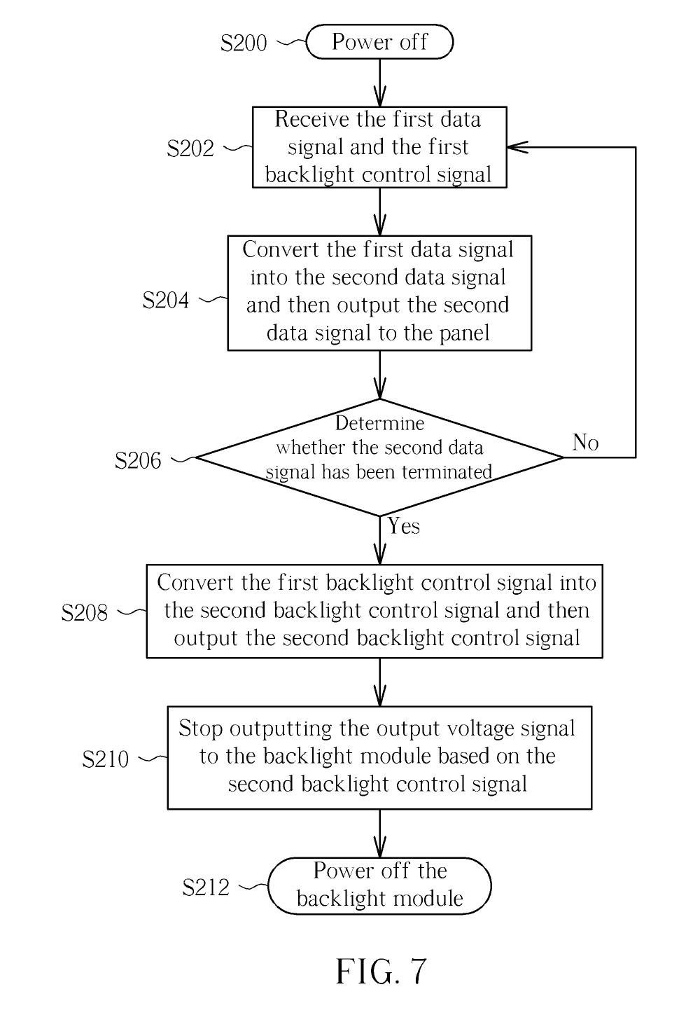

Referring to FIG. 7 along with FIGS. 3 and 4, FIG. 7 is a flowchart showing a backlight control method according to another embodiment of the invention. When the display device 4 is going to be powered off, the backlight control method of the invention comprises the following steps. In the beginning, step S200 is performed to power off the display device 4. Afterward, step S202 is performed to receive the first data signal 54 and the first backlight control signal 56. Step S204 is then performed to convert the first data signal 54 into the second data signal 58 and then output the second data signal 58 to the panel 40. Step S206 is then performed to determine whether the second data signal 58 has been terminated, wherein if it is YES, step S208 will be performed, otherwise step S202 is performed again to receive the first data signal 54 and the first backlight control signal 56 continuously. Step S208 is performed to convert the first backlight control signal 56 into the second backlight control signal 60 and then output the second backlight control signal 60. Step S210 is then performed to stop outputting the output voltage signal 62 to the backlight module 46 based on the second backlight control signal 60. Finally, step S212 is performed to power off the backlight module 46.

Still further, when the timing control module 44 converts the first backlight control signal 56 into the second backlight control signal 60, the invention may change the output mode of the backlight control signal, such as frequency, amplitude and so on, at the same time.

It should be noted that the invention can adjust the timing of the PWM signal and the enable signal at the same time or just adjust one of the both signals, so as to avoid generating power-on or power-off noise. In other words, the power-on or power-off noise can be avoided as long as one of the PWM signal and the enable signal is pulled high at time t3 and pulled low at time t5. If we cannot know which of the PWM signal and the enable signal will be inputted to the timing control module 44 first, the timing control module 44 has to perform the aforesaid adjustment for the PWM signal and the enable signal at the same time.

Compared to the prior art, the invention utilizes the timing control module to adjust the PWM signal and/or the enable signal in advance rather than inputting both of them to the backlight driving unit directly. The logic unit of the timing control module determines an optimal time for powering on/off the backlight module and determines a duty ratio and frequency for the PWM signal. Furthermore, the signal regenerating unit regenerates the PWM signal and the enable signal and then outputs both of them to the backlight driving unit. Accordingly, the backlight module will be powered on after the data signal reaches steady state, so as to avoid generating power-on noise. Moreover, the backlight module will be powered off after the data signal has been terminated and the power-off process is going to be performed, so as to avoid generating power-off noise.

Those skilled in the art will readily observe that numerous modifications and alterations of the device and method may be made while retaining the teachings of the invention.

What is claimed is:

1. A display device comprising:
a panel;
a receiving interface receiving a first data signal and a first backlight control signal with a first timing;
a timing control module electrically connected to the receiving interface and the panel, the timing control module converting the first data signal into a second data signal and then outputting the second data signal to the panel, based on the second data signal, the timing control module converting the first backlight control signal into a second backlight control signal with a second timing different from the first timing and then outputting the second backlight control signal;
a backlight module; and
a backlight driving unit electrically connected to the receiving interface, the timing control module and the backlight module, after receiving the second backlight control signal from the timing control module, the backlight driving unit being controlled by the second backlight control signal to output an output voltage signal to the backlight module.

2. The display device of claim 1, wherein the receiving interface further receives a first input voltage signal and provides the first input voltage signal for the backlight driving unit.

3. The display device of claim 1, wherein the first backlight control signal comprises at least one of a pulse width modulation signal and an enable signal.

4. The display device of claim 1, wherein the timing control module comprises:
a first receiving unit electrically connected to the receiving interface, the first receiving unit receiving the first data signal;
a processing unit electrically connected to the first receiving unit, the processing unit converting the first data signal into the second data signal;
a transmitting unit electrically connected to the processing unit and the panel, the transmitting unit transmitting the second data signal to the panel;
a control unit electrically connected to the processing unit and the panel, the control unit outputting control signals to the panel based on the second data signal;
a second receiving unit electrically connected to the receiving interface, the second receiving unit receiving the first backlight control signal;
a logic unit electrically connected to the control unit and the second receiving unit, the logic unit determining whether the second data signal has been transmitted to the panel or terminated; and
a signal regenerating unit electrically connected to the logic unit and the backlight driving unit, once the second data signal has been transmitted to the panel or terminated, the signal regenerating unit converting the first backlight control signal into the second backlight control signal.

5. The display device of claim 4, wherein after the transmitting unit transmits the second data signal to the panel, the logic unit determines that the second data signal has been transmitted to the panel after a first predetermined time.

6. The display device of claim 4, wherein the receiving interface further receives a second input voltage signal and provides the second input voltage signal for the timing control module.

7. The display device of claim 6, wherein after the timing control module receives the second input voltage signal, the logic unit determines that the second data signal has been transmitted to the panel after a second predetermined time.

8. The display device of claim 6, wherein after the timing control module receives the second input voltage signal and reaches steady state, the logic unit determines that the second data signal has been transmitted to the panel after a third predetermined time.

9. A backlight control method comprising steps of:
receiving a first data signal and a first backlight control signal with a first timing;
converting the first data signal into a second data signal and then outputting the second data signal to a panel;
based on the second data signal, converting the first backlight control signal into a second backlight control signal with a second timing different from the first timing and then outputting the second backlight control signal; and
based on the second backlight control signal, outputting an output voltage signal to a backlight module.

10. The backlight control method of claim 9, wherein the first backlight control signal comprises at least one of a pulse width modulation signal and an enable signal.

11. The backlight control method of claim 9, further comprising step of:
outputting control signals to the panel based on the second data signal.

12. The backlight control method of claim 9, wherein the step of converting the first backlight control signal into a second backlight control signal comprises steps of:
determining whether the second data signal has been transmitted to the panel or terminated; and
once the second data signal has been transmitted to the panel or terminated, converting the first backlight control signal into the second backlight control signal.

13. The backlight control method of claim 12, wherein the step of determining whether the second data signal has been transmitted to the panel comprises step of:
after transmitting the second data signal to the panel, determining that the second data signal has been transmitted to the panel after a first predetermined time.

14. The backlight control method of claim 12, wherein the step of determining whether the second data signal has been transmitted to the panel comprises step of:
receiving an input voltage signal; and
after receiving the input voltage signal, determining that the second data signal has been transmitted to the panel after a second predetermined time.
